(19) United States
(12) Patent Application Publication
(10) Pub. No.: US 2015/0231899 A1
(43) Pub. Date: Aug. 20, 2015

(54) THERMAL PRINTER

(71) Applicant: MITSUBISHI ELECTRIC CORPORATION, Tokyo (JP)

(72) Inventors: Yoshifumi YAMAMOTO, Tokyo (JP); Akihito ITO, Tokyo (JP); Osamu ASANO, Tokyo (JP); Kosuke ODA, Tokyo (JP); Masatomo SAKAGUCHI, Tokyo (JP)

(73) Assignee: MITSUBISHI ELECTRIC CORPORATION, Tokyo (JP)

(21) Appl. No.: 14/594,898

(22) Filed: Jan. 12, 2015

(30) Foreign Application Priority Data
Jan. 20, 2014 (JP) 2014-007717

(51) Int. Cl. B41J 11/04; B41J 2/335

(52) U.S. Cl. CPC B41J 11/04; B41J 2/335

(57) ABSTRACT

A thermal printer of the present invention includes: a thermal head; a platen roller disposed to face the thermal head; a first path that guides a recording paper drawn from a recording paper roll to one entrance of a gap between the thermal head and the platen roller such that a first main surface of the recording paper is on the thermal head side; a second path that guides the recording paper drawn from the recording paper roll to the other entrance of the gap between the thermal head and the platen roller such that a second main surface of the recording paper is on the thermal head side; and a switch guide that switches between the first path and the second path.

### BACKGROUND OF THE INVENTION

1. Field of the Invention

The present invention relates to a thermal printer and more particularly to a thermal printer that performs double-sided printing.

2. Description of the Background Art

Thermal printers (also referred to as thermal transfer printers or sublimation printers) are known that have a function of performing printing on both sides of recording paper, the thermal printers thermally transferring ink from an ink sheet to the recording paper for printing. Japanese Patent Application Laid-Open No. 2011-93255 discloses a technique for reversing a rolled recording medium by a reversal means to perform printing on both sides of the recording paper.

With a technique disclosed in Japanese Patent Application Laid-Open No. 2011-110789, recording paper drawn from a rolled recording medium to be cut is guided into a gap between a thermal head and a platen roller in one direction for printing on one main surface of the recording paper. Next, the recording paper is turned upside down and is guided into the gap between the thermal head and the platen roller in the other direction for printing on the other main surface of the recording paper.

The technique disclosed in Japanese Patent Application Laid-Open No. 2011-93255 has the reversal means of reversing the rolled recording medium, resulting in an increased size of the device. Moreover, the reversal means makes an inner mechanism complex, resulting in an increased manufacturing cost.

The technique disclosed in Japanese Patent Application Laid-Open No. 2011-110789 transports, to the inside of the thermal printer, the recording paper drawn from the rolled recording medium to be cut, so that rollers for transporting the recording paper are needed to be disposed at relatively narrow intervals, resulting in the increased number of components.

### SUMMARY OF THE INVENTION

It is an object of the present invention to provide a thermal printer capable of performing double-sided printing in a simple configuration.

A thermal printer of the present invention includes: a thermal head; a platen roller disposed to face the thermal head; a first path that guides a recording paper drawn from a recording paper roll to one entrance of a gap between the thermal head and the platen roller such that a first main surface of the recording paper is on the thermal head side; a second path that guides the recording paper drawn from the recording paper roll to the other entrance of the gap between the thermal head and the platen roller such that a second main surface of the recording paper is on the thermal head side; and a switch guide that switches between the first path and the second path.

The thermal printer of the present invention can perform double-sided printing in the simple configuration since the two paths, namely, the first path and the second path are provided and can be switched therebetween by the switch guide, the first path and the second path respectively guiding the first main surface and the second main surface of the recording paper drawn from the recording paper roll to the gap between the thermal head and the platen roller so as to be on the thermal head side.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view of a thermal printer according to a preferred embodiment of the present invention;

FIG. 2 is a diagram illustrating a transport path of recording paper shown in FIG. 1;

FIGS. 3A and 3B are diagrams showing a configuration and operations of a switch guide in the thermal printer according to the preferred embodiment of the present invention;

FIGS. 4A and 4B are diagrams showing a configuration and operations of an auxiliary guide in the thermal printer according to the preferred embodiment of the present invention;

FIG. 5 is a functional block diagram of the thermal printer according to the preferred embodiment of the present invention;

FIG. 6 is a flow chart showing printing operations of the thermal printer according to the preferred embodiment of the present invention;

FIGS. 7 to 10 are diagrams explaining back-side printing operations of the thermal printer according to the preferred embodiment of the present invention; and

FIGS. 11 to 13 are diagrams explaining front-side printing operations of the thermal printer according to the preferred embodiment of the present invention.

### DESCRIPTION OF THE PREFERRED EMBODIMENT

### First Preferred Embodiment

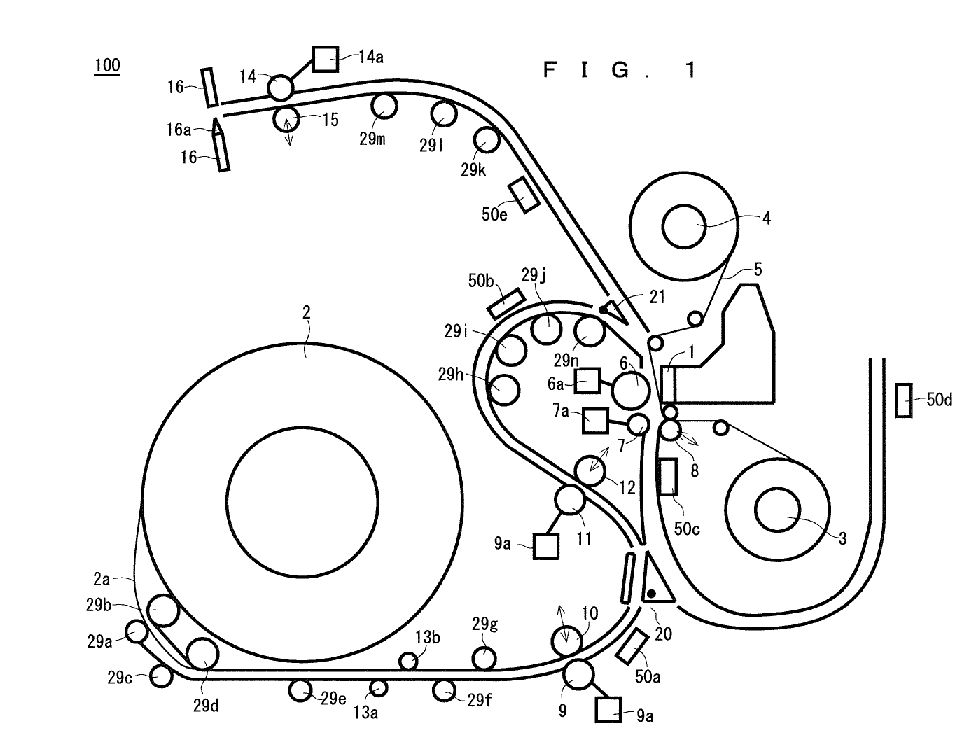

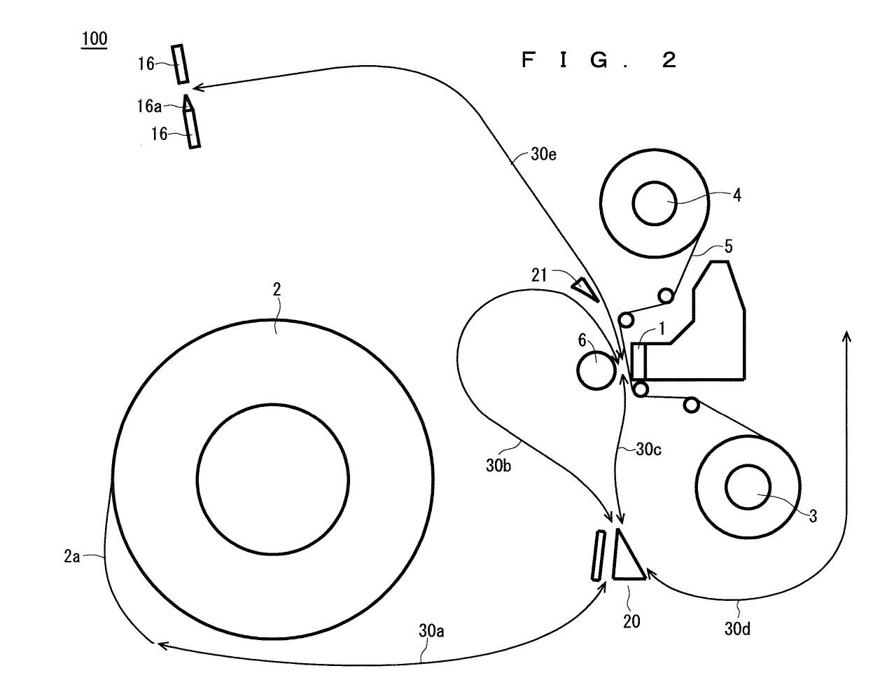

FIG. 1 is a diagram showing a configuration of a thermal printer 100 according to a preferred embodiment of the present invention. FIG. 2 is a diagram illustrating a transport path of recording paper in the thermal printer 100 in FIG. 1. As shown in FIG. 1, the thermal printer 100 includes a thermal head 1 and a platen roller 6 disposed to face the thermal head 1. Moreover, the thermal printer 100 includes an ink sheet winding bobbin 3 that winds an ink sheet 5 and an ink sheet unwinding bobbin 4 that unwinds the ink sheet 5. A recording paper roll 2 in which recording paper 2a is rolled up in a roll shape is set in the thermal printer 100.

As shown in FIG. 2, the thermal printer 100 includes a guide path 30a that guides the recording paper 2a drawn from the recording paper roll 2 to a switch guide 20. The thermal printer 100 includes a first path 30b that guides a first main surface (namely, back side) of the recording paper 2a to one entrance of a gap between the thermal head 1 and the platen roller 6 so as to be on the thermal head 1 side. The thermal printer 100 includes a second path 30c that guides a second main surface (namely, front side) of the recording paper 2a drawn from the recording paper roll 2 to the other entrance of the gap between the thermal head 1 and the platen roller 6 so as to be on the thermal head 1 side.

The thermal printer 100 further includes the switch guide 20 that switches between the first path 30b and the second path 30c. The switch guide 20 will be described below.

The thermal printer 100 further includes an auxiliary guide 21 that supports the transport path of the recording paper 2a. The auxiliary guide 21 will be described below.

The thermal printer 100 further includes a housing path 30d that houses the recording paper 2a guided to the one entrance of the gap between the thermal head 1 and the platen roller 6 from the first path 30b for printing. The housing path 30d is curved in the same direction as the winding direction of the recording paper roll 2.

The thermal printer 100 further includes an ejection path 30e that guides the recording paper 2a to an ejection opening 16, the recording paper 2a having passed through the second path 30c. The ejection opening 16 is provided with a cutter 16a that cuts the recording paper 2a. In the preferred embodiment, the ejection path 30e has a distance greater than an effective print length in a unit screen of the ink sheet 5 used in the thermal printer 100. Here, the distance of the ejection path 30e is the distance of the transport path from the gap between the thermal head 1 and the platen roller to the ejection opening 16.

A yellow (Y) region in the unit screen, a magenta (M) region in the unit screen, a cyan (C) region in the unit screen, and an overcoat (OP) region in the unit screen are disposed in the stated order as one group that is repeatedly disposed to form the ink sheet 5. Margins (for example, 10 mm) that are not used for printing are provided at both ends of the ink sheet 5 in a longitudinal direction in each unit screen. A region except for the margins in each unit screen is an effective print region used for printing. The length of the effective print region in the longitudinal direction of the ink sheet 5 in each unit screen is referred to as the effective print length.

The guide path 30a includes a paper feed roller 9 that transports the recording paper 2a and a pinch roller 10 that faces the paper feed roller 9. A paper feed motor 9a drives the paper feed roller 9. A cam, which is not shown, changes a position of the pinch roller 10 between a state where the pinch roller 10 is pressed against the paper feed roller 9 and a state where the pinch roller 10 is kept a distance from the paper feed roller 9. A motor rotates the cam, the motor and the cam not being shown.

The guide path 30a includes guide rollers 29a, 29b, 29c, 29d, 29e, 29f, 29g that smoothly transport the recording paper 2a. A first sensor 50a is provided upstream of the switch guide 20 in the guide path 30a.

The guide path 30a includes a dust removing roller 13a and a dust removing roller 13b. The dust removing rollers 13a and 13b are made of, for example, silicon and remove dust adhering to the recording paper 2a.

The first path 30b includes a paper feed roller 11 that transports the recording paper 2a and a pinch roller 12 that faces the paper feed roller 11. A paper feed motor 9a common to the paper feed roller 9 rotates the paper feed roller 11. A cam, which is not shown, changes a position of the pinch roller 12 between a state where the pinch roller 12 is pressed against the paper feed roller 11 and a state where the pinch roller 12 is kept a distance from the paper feed roller 11. A motor rotates the cam, the motor and the cam not being shown.

The first path 30b includes guide rollers 29h, 29i, 29j, 29n that smoothly transport the recording paper 2a. A second sensor 50b is provided, for example, between the guide roller 29i and the guide roller 29j in the first path 30b.

The second path 30c includes a grip roller 7 that transports the recording paper 2a and a pinch roller 8 that faces the grip roller 7. A transport motor 7a rotates the grip roller 7. A cam, which is not shown, changes a position of the pinch roller 8 between a state where the pinch roller 8 is pressed against the grip roller 7 and a state where the pinch roller 8 is kept a distance from the grip roller 7. A motor rotates the cam, the motor and the cam not being shown. A third sensor 50c is provided upstream of the pinch roller 8 in the second path 30c.

The housing path 30d includes a fourth sensor 50d at its end opposite to the switch guide 20.

The ejection path 30e includes a paper ejection roller 14 that transports the recording paper 2a and a pinch roller 15 that faces the paper ejection roller 14. A paper ejection motor 14a rotates the paper ejection roller 14. A cam, which is not shown, changes a position of the pinch roller 15 between a state where the pinch roller 15 is pressed against the paper ejection roller 14 and a state where the pinch roller 15 is kept a distance from the paper ejection roller 14. A motor rotates the cam, the motor and the cam not being shown.

The ejection path 30e includes guide rollers 29k, 29l, 29m that smoothly transport the recording paper 2a. A fifth sensor 50e is provided between the auxiliary guide 21 and the guide roller 29k in the ejection path 30e.

The paper feed motor 9a and the transport motor 7a are stepping motors and are driven by drive pulses sent from a motor controller 60, which will be described below. The paper ejection motor 14a is a DC motor and is driven by the motor controller 60.

The motors (not shown) that rotate the cams to change the positions of the pinch rollers 8, 10, 12, and 15, the motor that rotates the recording paper roll 2, the motor that rotates the ink sheet winding bobbin 3, and the motor that rotates the ink sheet unwinding bobbin 4 for unwinding the ink sheet 5 are the DC motors and are driven by the motor controller 60, which will be described below.

### <Switch Guide>

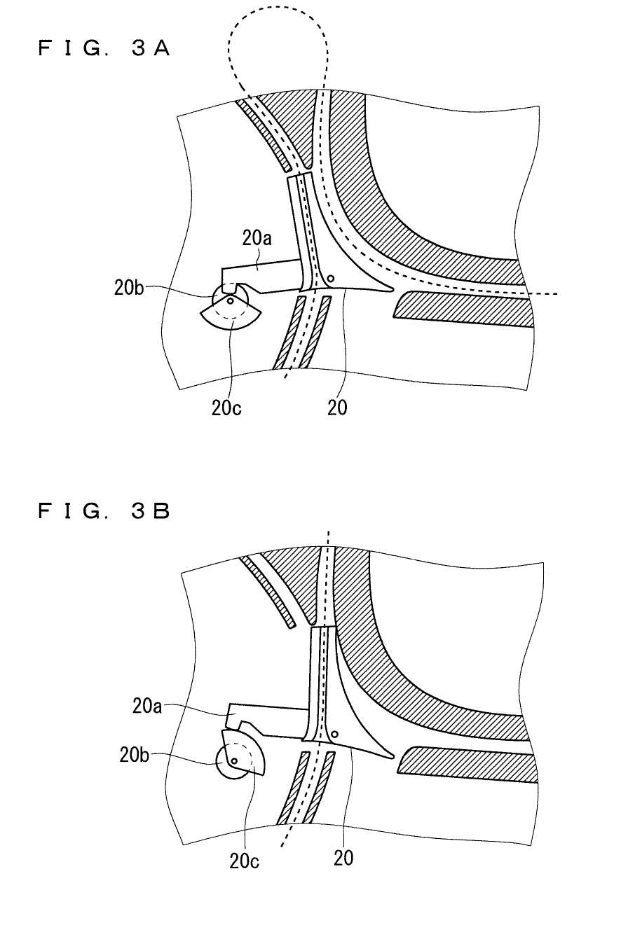

FIGS. 3A and 3B are diagrams showing a configuration and operations of the switch guide 20 in the thermal printer 100. In FIGS. 3A and 3B, a broken line illustrates the transport path of the recording paper 2a. FIG. 3A shows a state where the switch guide 20 connects the guide path 30a to the first path 30b, namely, the state where the switch guide 20 selects the first path 30b. In the state where the switch guide 20 selects the first path 30b, the second path 30c is simultaneously connected to the housing path 30d.

On the other hand, FIG. 3B shows a state where the switch guide 20 connects the guide path 30a to the second path 30c, namely, the state where the switch guide 20 selects the second path 30c.

As shown in FIGS. 3A and 3B, a switch guide motor 20b rotates a cam 20c to change an angle of a lever 20a pressed against the cam 20c. The lever 20a is fixed to the switch guide 20, so that a change in the angle of the lever 20a changes the angle of the switch guide 20 to cause the state shown in FIG. 3A or FIG. 3B.

### <Auxiliary Guide>

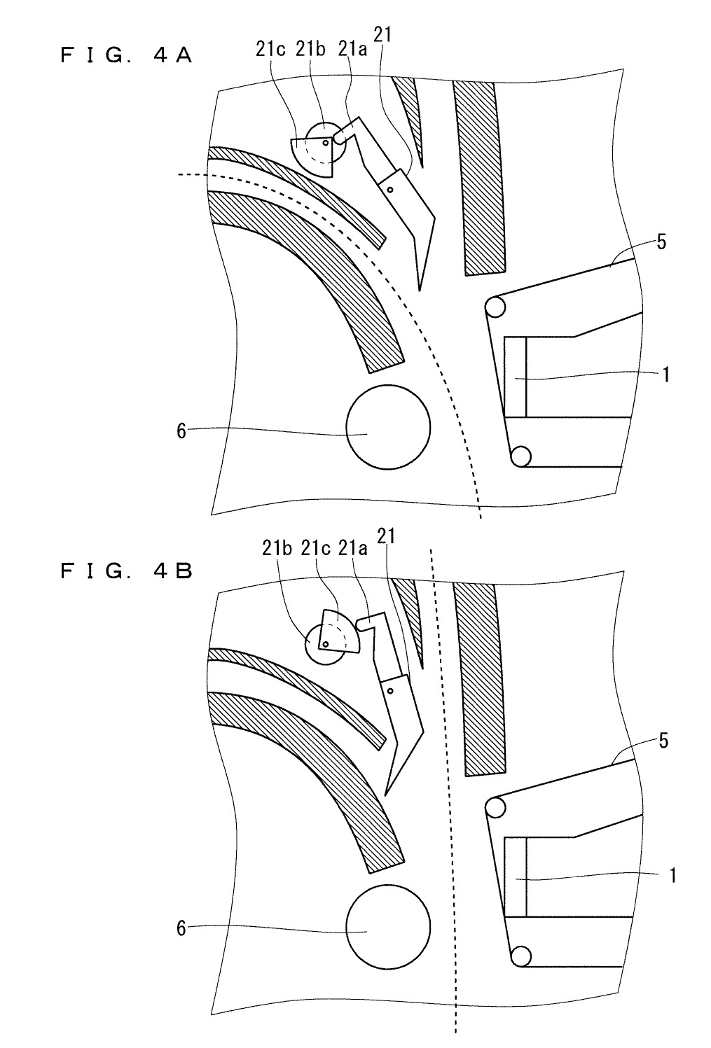

FIGS. 4A and 4B are diagrams showing a configuration and operations of the auxiliary guide 21 in the thermal printer 100. In FIGS. 4A and 4B, a broken line illustrates the transport path of the recording paper 2a. FIG. 4A shows a state where the auxiliary guide 21 supports the transport path such that the first path 30b is smoothly connected to the other entrance of the gap between the thermal head 1 and the platen roller 6. In other words, it is the state where the auxiliary guide 21 selects the first path 30b.

On the other hand, FIG. 4B shows a state where the auxiliary guide 21 supports the transport path such that the ejection path 30e is smoothly connected to the other entrance of the gap between the thermal head 1 and the platen roller 6. In other words, it is the state where the auxiliary guide 21 selects the ejection path 30e.

As shown in FIGS. 4A and 4B, an auxiliary guide motor 21b rotates a cam 21c to change an angle of a lever 21a pressed against the cam 21c, causing a change in the angle of the auxiliary guide 21. The lever 21a is fixed to the auxiliary guide 21, so that the change in the angle of the auxiliary guide 21 causes the state shown in FIG. 4A or FIG. 4B.

### <Functional Block Diagram>

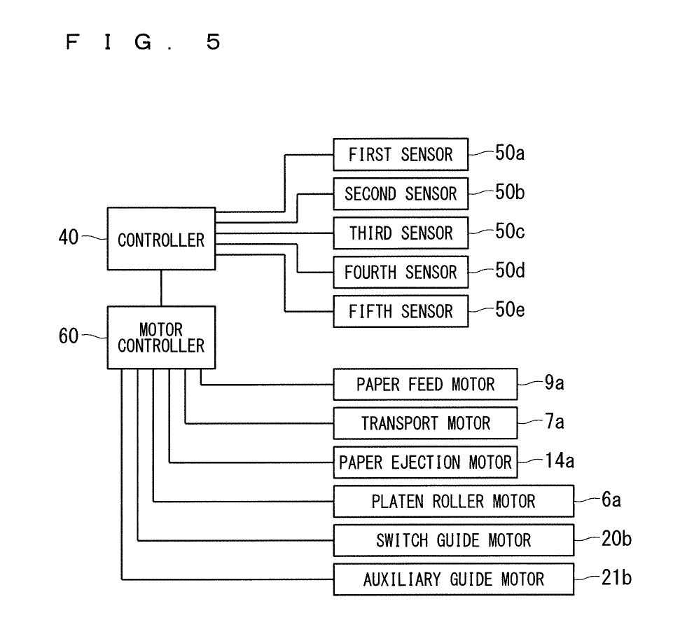

FIG. 5 is a functional block diagram of the thermal printer 100 according to the preferred embodiment of the present invention. The thermal printer 100 includes a controller 40 that controls printing operations. The controller 40 receives detection signals for indicating the detection of the recording paper 2a from a first sensor 50a, a second sensor 50b, a third sensor 50c, a fourth sensor 50d, and a fifth sensor 50e. The thermal printer 100 includes the motor controller 60 that controls each motor in the thermal printer 100. The controller 40 controls the motor controller 60 in response to the detection signals sent from the first sensor 50a, the second sensor 50b, the third sensor 50c, the fourth sensor 50d, and the fifth sensor 50e. The motor controller 60 outputs the drive pulses for driving each stepping motor in the thermal printer 100. As shown in FIG. 5, the motor controller 60 sends the drive pulses to the paper feed motor 9a and the transport motor 7a. Moreover, the paper ejection motor 14a, a platen roller motor 6a that rotates the platen roller 6, the switch guide motor 20b, and the auxiliary guide motor 21b are the DC motors and are driven by the motor controller 60.

The motor controller 60 also drives the DC motors (not shown) that rotate the cams to change the positions of the pinch rollers 8, 10, 12, and 15. The motor controller 60 also drives the DC motors (not shown) that rotate the recording paper roll 2, the ink sheet winding bobbin 3, and the ink sheet unwinding bobbin 4.

To suppress slack in the recording paper 2a during transport, torque limiters are provided between the paper feed motor 9a and the paper feed rollers 9, 11 and between the paper ejection motor 14a and the paper ejection roller 14.

### <Operations>

The thermal printer 100 of the preferred embodiment has a first print function (operation mode) of switching the switch guide 20 to the first path 30b (namely, causing the switch guide 20 to be in the state of FIG. 3A) and guiding the recording paper 2a into the first path 30b for printing on the first main surface (namely, back side) of the recording paper 2a.

The thermal printer 100 of the preferred embodiment further has a rewind function (operation mode) of rewinding the recording paper 2a on which printing has been performed by the first print function (operation mode).

The thermal printer 100 of the preferred embodiment further has a second print function (operation mode) of switching the switch guide 20 to the second path 30c (namely, causing the switch guide to be in the state of FIG. 3B) after the recording paper 2a has been rewound by the rewind function (operation mode) and guiding the recording paper 2a into the second path 30c for printing on the second main surface (namely, front side) of the recording paper 2a. Moreover, the thermal printer 100 of the preferred embodiment performs printing on both the first and second main surfaces of the recoding paper 2a being connected to the recording paper roll 2.

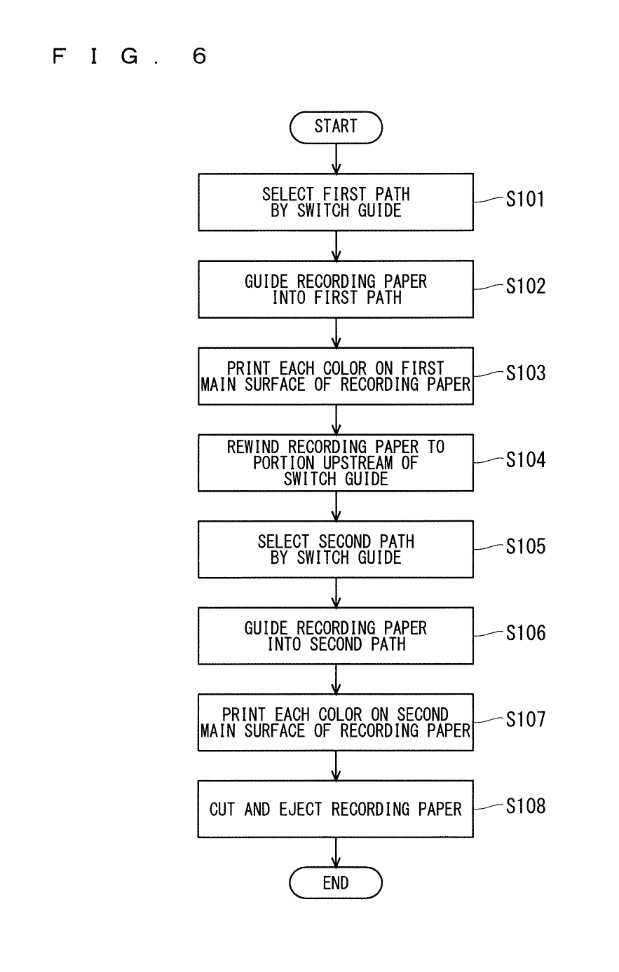

FIG. 6 is a flow chart showing printing operations of the thermal printer 100. First, the thermal printer 100 performs printing on the first main surface of the recording paper 2a (steps S101 to S103 in FIG. 6). This corresponds to the first print function (operation mode). Next, the thermal printer 100 rewinds the recording paper 2a (step S104 in FIG. 6). This corresponds to the rewind function (operation mode). Then, the thermal printer 100 performs printing on the second main surface of the recording paper 2a (steps S105 to S107 in FIG. 6). This corresponds to the second print function (operation mode).

### <Back-Side Printing Operations>

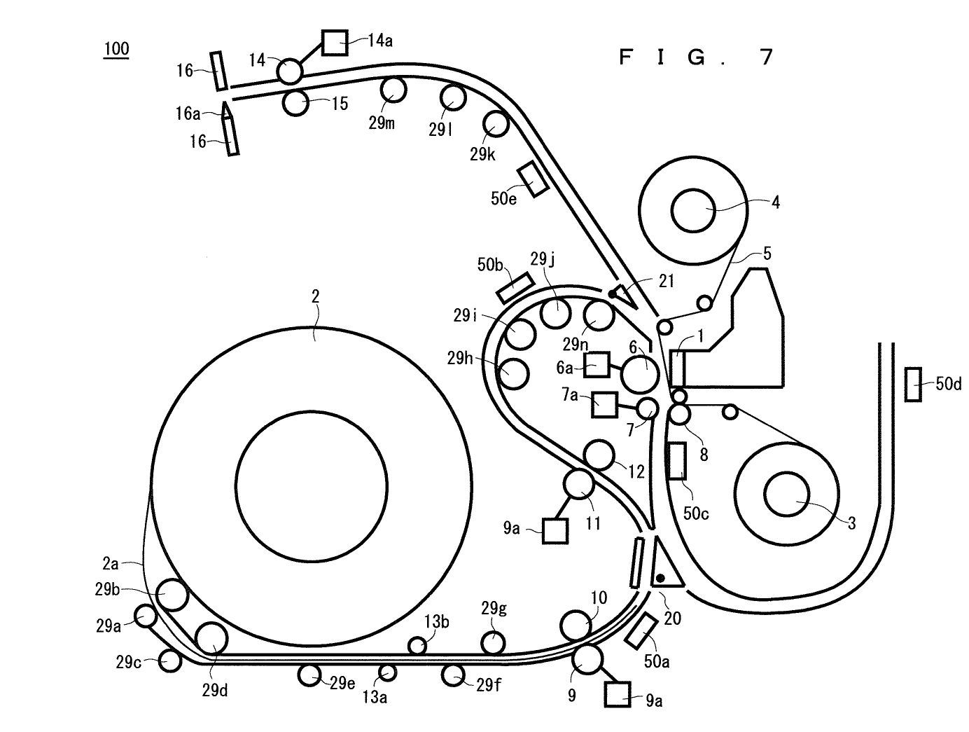

First, back-side printing operations will be described below with reference to the flow chart of FIG. 6 and FIGS. 7 to 10. As shown in FIG. 7, a tip of the recording paper 2a is located at the position capable of being detected by the first sensor 50a in the initial state. At this time, only the first sensor 50a outputs the detection signal indicating the detection of the recording paper 2a while the other sensors (second to fifth sensors 50b, 50c, 50d, 50e) do not output the detection signals. In this initial state, the motor controller 60 controls the drive of the switch guide motor 20b and causes the switch guide 20 to select the first path 30b (step S101 in FIG. 6). In other words, the switch guide 20 is caused to be in the state of FIG. 3A. At the same time, the motor controller 60 causes the pinch roller 10 to be pressed against the paper feed roller 9 via the recording paper 2a. The motor controller 60 simultaneously causes the pinch roller 12 to be pressed against the paper feed roller 11. In addition, the motor controller 60 controls the drive of the auxiliary guide motor 21b and causes the auxiliary guide 21 to select the first path 30b. In other words, the auxiliary guide 21 is caused to be in the state of FIG. 4A.

Next, in the step S102 in FIG. 6, the motor controller 60 controls the drive of the paper feed motor 9a to rotate the paper feed roller 9, and thus the recording paper 2a passes through the switch guide 20 to be guided into the first path 30b. The motor, which is not shown, rotates the recording paper roll 2 in the transport direction in synchronization with the rotation of the paper feed roller 9. When the motor controller 60 outputs the predetermined number of drive pulses to the paper feed motor 9a, the recording paper 2a reaches the portion between the paper feed roller 11 and the pinch roller 12. The motor controller 60 continues to drive the paper feed motor 9a. When the recording paper 2a reaches the second sensor 50b, the second sensor 50b outputs the detection signal to the controller 40. When the controller 40 receives the detection signal from the second sensor 50b, the motor controller 60 drives the transport motor 7a to rotate the grip roller 7. If the detection signal is not output from the second sensor 50b despite the fact that the motor controller 60 outputs the drive pulses for the recording paper 2a to reach the second sensor 50b, the controller 40 gives a warning about a paper jam, for example, to a user.

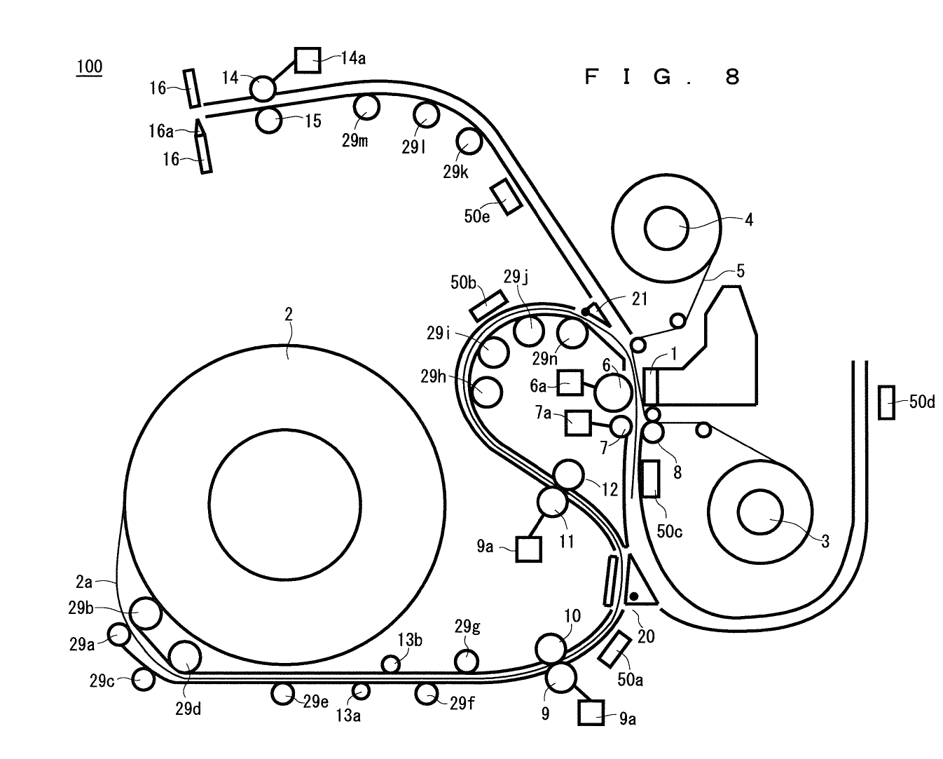

As the motor controller 60 continues to drive the paper feed motor 9a, the recording paper 2a is guided to the one entrance of the gap between the thermal head 1 and the platen roller 6. As the motor controller 60 continues to drive the paper feed motor 9a, the recording paper 2a passes through the gap between the thermal head 1 and the platen roller 6 to reach the third sensor 50c. FIG. 8 shows this state. The motor controller 60 rotates the ink sheet winding bobbin 3 and the ink sheet unwinding bobbin 4 to transport the screen of yellow (Y) of the ink sheet 5 to a printing position.

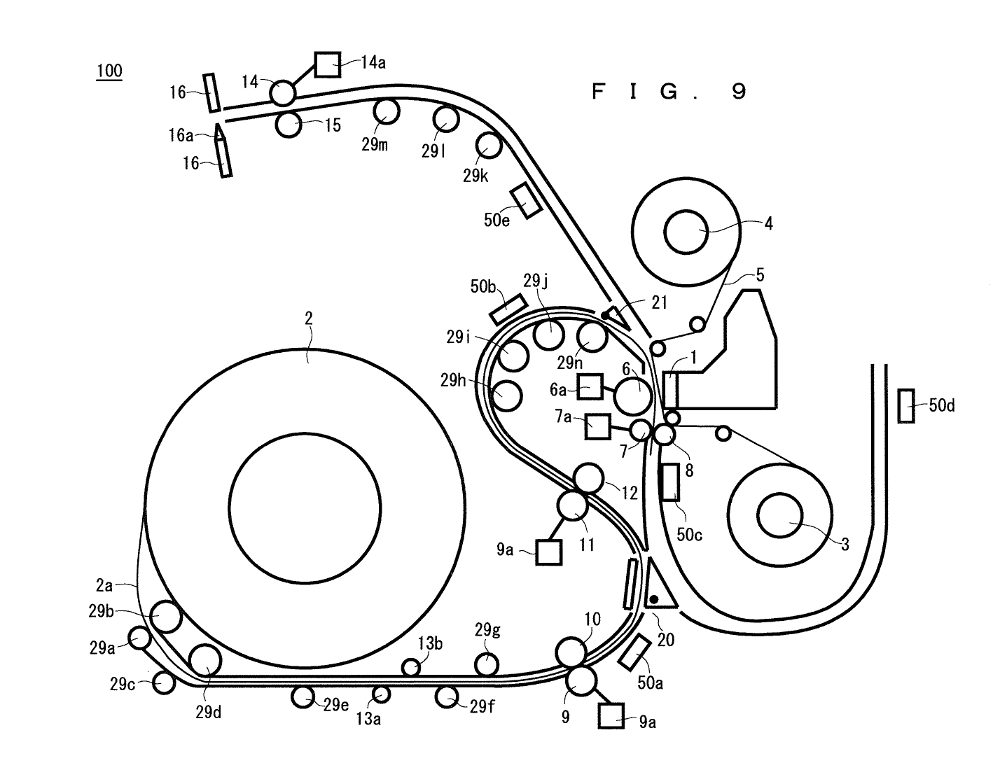

In the state shown in FIG. 8, the third sensor 50c outputs the detection signal. When receiving the detection signal from the third sensor 50c, the controller 40 stops the paper feed motor 9a and the transport motor 7a. At the same time, the pinch roller 8 is pressed against the grip roller 7 via the recording paper 2a. Then, the motor controller 60 controls the transport motor 7a to rotate the grip roller 7 and transports the recording paper 2a in the direction opposite to the direction from which the recording paper 2a is transported. At this time, the motor controller 60 also rotates the paper feed roller 9 and the paper feed roller 11 in synchronization with the rotation of the grip roller 7. When outputting the predetermined number of drive pulses to the transport motor 7a, the motor controller 60 stops the transport motor 7a. Then, the platen roller 6 is pressed against the thermal head 1 via the recording paper 2a and the ink sheet 5. FIG. 9 shows this state.

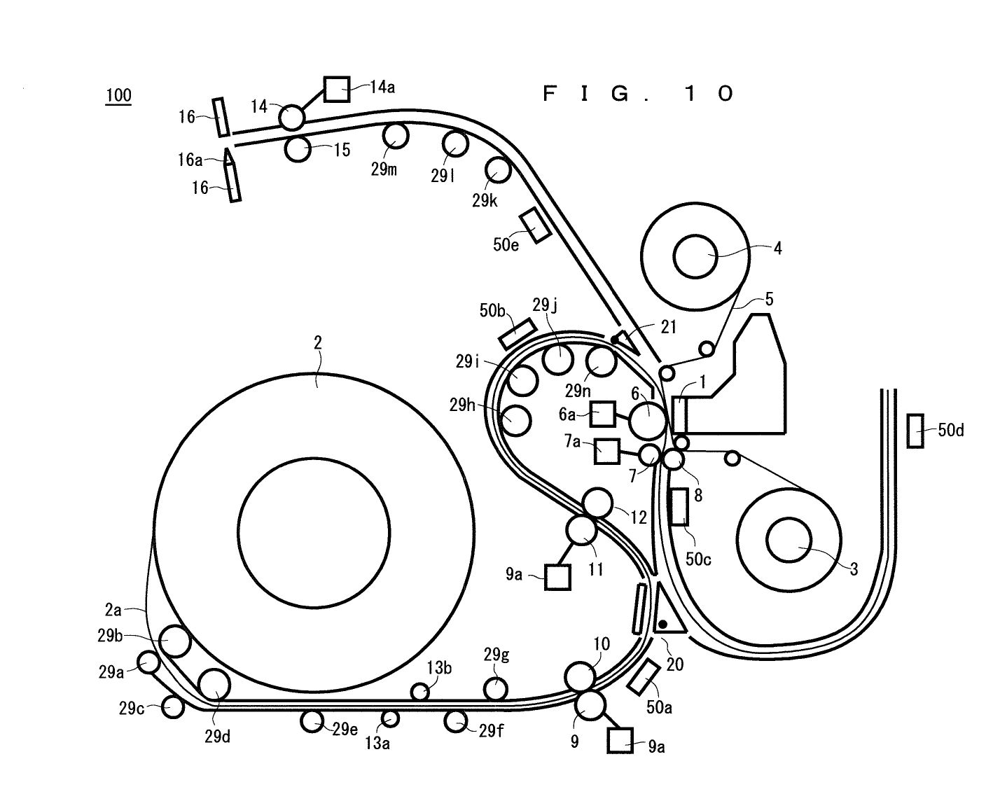

Next, in the step S103 in FIG. 6, printing on the first main surface (namely, back side) of the recording paper 2a is started. In other words, in the state of FIG. 9, the motor controller 60 transports the ink sheet 5 and also rotates the platen roller 6 and the grip roller 7 to transport the recording paper 2a. After the ink sheet 5 and the recording paper 2a have been transported by the predetermined number of drive pulses, the thermal head 1 is heated to start printing yellow (Y). The recording paper 2a on which yellow (Y) has been printed passes through the second path 30c and is housed in the housing path 30d via the switch guide 20. As the recording paper 2a is transported by the predetermined number of drive pulses, the ink sheet 5 is pressed against the recoding paper 2a and is transported, completing printing of yellow (Y). FIG. 10 shows this state.

In the state of FIG. 10, the fourth sensor 50d detects the recording paper 2a and outputs the detection signal. If the detection signal is not output from the fourth sensor 50d despite the fact that the printing of yellow (Y) is completed, the controller 40 gives a warning about a paper jam, for example, to the user.

Next, the motor controller 60 releases the thermal head 1 from the pressure of the platen roller 6 and rotates the grip roller 7 to rewind the recording paper 2a to the position shown in FIG. 8. At this time, the paper feed roller 9, the paper feed roller 11, and the recording paper roll 2 are also rotated in synchronization with the grip roller 7. The motor controller 60 rotates the ink sheet winding bobbin 3 and the ink sheet unwinding bobbin 4 to transport the screen of magenta (M) of the ink sheet 5 to a printing position. Then, magenta (M) is printed in the same operation as the printing of yellow (Y). Hereinafter, the similar printing operation is repeated to print cyan (C) and over coat (OP). This completes the printing on the first main surface (namely, back side) of the recording paper 2a.

### <Front-Side Printing Operations>

Printing is performed on the second main surface (namely, front side) of the recording paper 2a, followed by the printing on the first main surface (namely, back side) of the recording paper 2a. Front-side printing operations will be described below with reference to the flow chart of FIG. 6 and FIGS. 11 to 13.

When the back-side printing operations are completed, the recording paper 2a is in the state of FIG. 10. The motor controller 60 releases the thermal head 1 from the pressure of the platen roller 6 and also releases the grip roller 7 from the pressure of the pinch roller 8. Then, the motor controller 60 rotates the recording paper roll 2 in the direction to which the recording paper 2a is rewound. The paper feed roller 9 and the paper feed roller 11 are rotated in synchronization with the rotation of the recording paper roll 2. As the recording paper 2a passes through the first sensor 50a, the detection signal output from the first sensor 50a is changed from present to absent. When the output of the first sensor 50a is changed, the motor controller 60 outputs the predetermined number of drive pulses and subsequently stops to transport the recording paper 2a. In the operations as described above, the recording paper 2a is rewound to the portion upstream of the switch guide 20 (step S104 in FIG. 6).

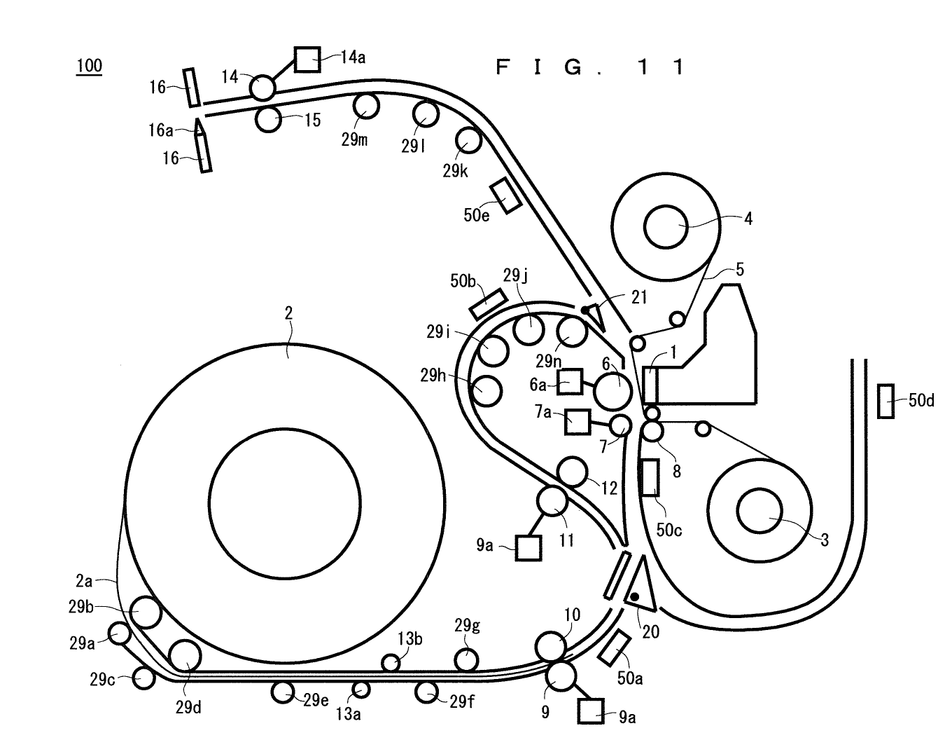

Next, in the step S105 in FIG. 6, the motor controller 60 controls the drive of the switch guide motor 20b and causes the switch guide 20 to select the second path 30c. In other words, the switch guide 20 is caused to be in the state of FIG. 3B. At the same time, the motor controller 60 controls the drive of the auxiliary guide motor 20b and causes the auxiliary guide 21 to select the ejection path 30e. In other words, the auxiliary guide 21 is caused to be in the state of FIG. 4B. The motor controller 60 causes the pinch roller 10 to be pressed against the paper feed roller 9 via the recording paper 2a. FIG. 11 shows this state.

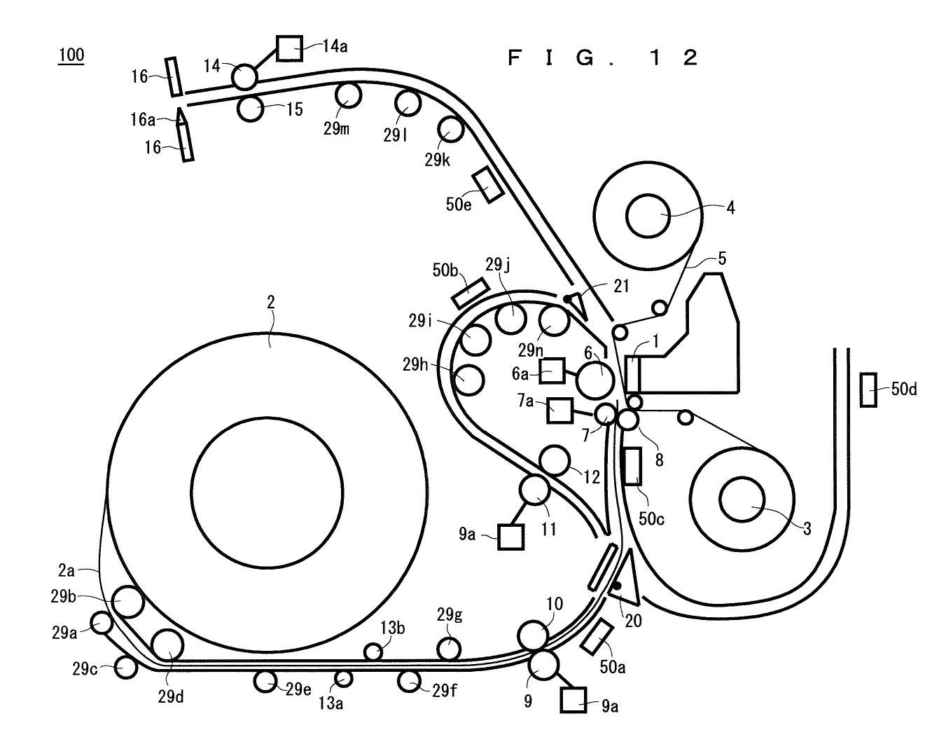

Next, in the step S106 in FIG. 6, the motor controller 60 controls the drive of the paper feed motor 9a to rotate the paper feed roller 9, and thus the recording paper 2a passes through the switch guide 20 to be guided into the second path 30c. When the recording paper 2a reaches the third sensor 50c, the third sensor 50c outputs the detection signal. When the controller 40 receives the detection signal from the third sensor 50c, the motor controller 60 further transports the recording paper 2a by the predetermined number of drive pulses. The motor controller 60 causes the pinch roller 8 to be pressed against the grip roller 7 via the recording paper 2a. FIG. 12 shows this state.

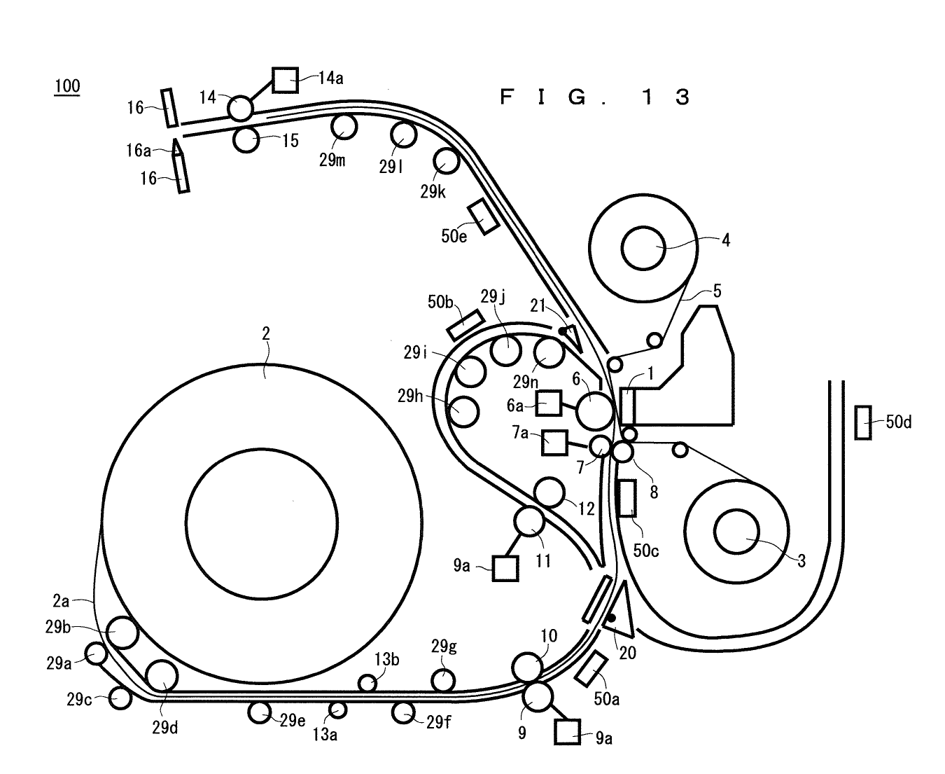

Furthermore, the motor controller 60 transports the recording paper 2a, and as the recording paper 2a reaches the fifth sensor 50e, the fifth sensor 50e outputs the detection signal. When the controller 40 receives the detection signal from the fifth sensor 50e, the motor controller 60 further transports the recording paper 2a by the predetermined number of drive pulses. Thus, the recording paper 2a is transported to a printing start position. The motor controller 60 rotates the ink sheet winding bobbin 3 and the ink sheet unwinding bobbin 4 to transport the screen of yellow (Y) of the ink sheet 5 to the printing position. The motor controller 60 causes the platen roller 6 to be pressed against the thermal head 1 via the recording paper 2a and the ink sheet 5. FIG. 13 shows this state. The recording paper 2a that has been transported to the printing start position does not reach the ejection opening 16.

Next, in the step S107 in FIG. 6, printing on the second main surface (namely, front side) of the recording paper 2a is started. In other words, in the state of FIG. 13, the motor controller 60 transports the ink sheet 5 and also rotates the platen roller 6 and the grip roller 7 to transport the recording paper 2a in the rewind direction while the thermal head 1 is heated to print yellow (Y). The recording paper 2a and the ink sheet 5 are transported by the predetermined number of drive pulses, completing printing of yellow (Y).

Next, the motor controller 60 releases the thermal head 1 from the pressure of the platen roller 6 and rotates the grip roller 7 to transport the recording paper 2a to the position shown in FIG. 13. At this time, the paper feed roller 9, the paper feed roller 11, and the recording paper roll 2 are also rotated in synchronization with the grip roller 7. The motor controller 60 rotates the ink sheet winding bobbin 3 and the ink sheet unwinding bobbin 4 to transport the screen of magenta (M) of the ink sheet 5 to the printing position. Then, magenta (M) is printed in the same operation as the printing of yellow (Y). Hereinafter, the similar printing operation is repeated to print cyan (C) and over coat (OP). This completes the printing on the second main surface (namely, back side) of the recording paper 2a.

After the completion of the printing on the second main surface (namely, front side) of the recording paper 2a, the motor controller 60 rotates the grip roller 7, the paper feed roller 9, and the recording paper roll 2 to transport the recording paper 2a to the ejection opening 16 while the motor controller 60 causes the pinch roller 8 to be pressed against the grip roller 7. When the recording paper 2a reaches the fifth sensor 50e, the fifth sensor 50e outputs the detection signal. The detection signal from the fifth sensor 50e is used to monitor a paper jam. The motor controller 60 causes the pinch roller 15 to be pressed against the paper ejection roller 14 via the recording paper 2a, rotates the paper ejection roller 14, the grip roller 7, the paper feed roller 9, and the recording paper roll 2, and further transports the recording paper 2a by the predetermined number of drive pulses. As a result, a portion of the recording paper 2a on which printing has been performed is exposed to the outside of the case of the thermal printer 100 from the ejection opening 16. Then, the recording paper 2a is cut with the cutter 16a provided at the ejection opening 16, and the printed matter is ejected from the ejection opening 16 (step S108 in FIG. 6).

### <Effects>

The thermal printer 100 of the preferred embodiment includes: the thermal head 1; the platen roller 6 disposed to face the thermal head 1; the first path 30b that guides the recording paper 2a drawn from the recording paper roll 2 to the one entrance of the gap between the thermal head 1 and the platen roller 6 such that the first main surface of the recording paper 2a is on the thermal head 1 side; the second path 30c that guides the recording paper 2a drawn from the recording paper roll 2 to the other entrance of the gap between the thermal head 1 and the platen roller 6 such that the second main surface of the recording paper 2a is on the thermal head 1 side; and the switch guide 20 that switches between the first path 30b and the second path 30c.

Therefore, the thermal printer 100 of the preferred embodiment can perform double-sided printing in the simple configuration since the two paths, namely, the first path 30b and the second path 30c are provided and can be switched therebetween by the switch guide 20, the first path 30b and the second path 30c respectively guiding the first main surface and the second main surface of the recording paper 2a drawn from the recording paper roll 2 to the gap between the thermal head 1 and the platen roller 6. The thermal printer 100 of the preferred embodiment can perform printing on both the sides without the mechanism for reversing the recording paper roll 2, achieving double-sided printing in the more simple configuration than the conventional configuration. The thermal printer 100 has the more simple configuration than the conventional configuration, allowing for the miniaturization thereof. Moreover, the thermal printer 100 does not include the complex mechanism for reversing the recording paper roll 2, allowing for a reduced manufacturing cost.

After printing on the first main surface has been performed, the thermal printer 100 of the preferred embodiment rewinds the recording paper 2a around the recording paper roll 2 to subsequently perform printing on the second main surface, eliminating the need to cut the recording paper 2a during printing. This can reduce the number of rollers for transporting the recording paper 2a compared to the case where the recording paper 2a is cut during printing. In other words, the number of components is reduced compared to the conventional configuration, achieving the simplified configuration of the thermal printer 100. The number of components is reduced compared to the conventional configuration, achieving the miniaturization of the thermal printer 100.

The thermal printer 100 of the preferred embodiment further includes: the first print function of switching the switch guide 20 to the first path 30b and guiding the recording paper 2a into the first path 30b to perform printing on the first main surface of the recording paper 2a; the rewind function of rewinding the recording paper 2a on which printing has been performed by the first print function; and the second print function of switching the switch guide 20 to the second path 30c after the recording paper 2a has been rewound by the rewind function and guiding the recording paper 2a into the second path 30c to perform printing on the second main surface of the recording paper 2a. The thermal printer 100 performs printing on both the first and second main surfaces of the recording paper 2a being connected to the recording paper roll 2.

Therefore, the thermal printer 100 of the preferred embodiment has the first print function, whereby printing can be performed on the first main surface of the recording paper 2a using the first path 30b. The thermal printer 100 has the rewind function, whereby the recording paper 2a having the first main surface on which printing has been performed can be rewound around the recording paper roll 2. The thermal printer 100 has the second print function, whereby printing can be performed on the second main surface of the recording paper 2a using the second path 30c.

The thermal printer 100 of the preferred embodiment performs printing on both the first and the second main surfaces of the recording paper 2a being connected to the recording paper roll 2. This can reduce the number of rollers for transporting and rewinding the recording paper 2a compared to the case where printing is performed on the first and second main surfaces of the recording paper 2a that has been cut from the recording paper roll 2. The reduction in the number of components can lead to the miniaturization of the thermal printer 100 and the reduced manufacturing cost.

The thermal printer 100 further includes the housing path 30d that houses the recording paper 2a on which printing has been performed by the first print function. The housing path 30d is curved in the same direction as a winding direction of the recording paper roll 2.

Therefore, the housing path 30d that houses the recording paper 2a on which printing has been performed by the first print function can prevent a stain and dust from adhering to the recording paper 2a compared to the case where the housing path 30d is not provided and the recording paper 2a is exposed to the outside of the case. Furthermore, the recording paper 2a is curled in the winding direction thereof, and thus the housing path 30d is provided to be bent in the same direction as the winding direction of the recording paper 2a. This can suppress a paper jam when the recording paper 2a is guided into the housing path 30d.

The thermal printer 100 further includes the ejection path 30e that guides the recording paper 2a to the ejection opening 16, the recording paper 2a having passed through the second path 30c. The ejection opening 16 is provided with the cutter 16a that cuts the recording paper 2a. The ejection path 30e has a distance greater than the effective print length in the unit screen of the ink sheet 5 used in the thermal printer 100.

Therefore, the ejection path 30e has a distance greater than the effective print length in the unit screen of the ink sheet 5, whereby the tip of the recording paper 2a does not reach the ejection opening 16 upon printing on the second main surface of the recording paper 2a. Thus, the first main surface (namely, back side) of the recording paper 2a can be prevented from damage caused by the cutter 16a at the ejection opening 16. Since the thermal printer 100 of the preferred embodiment performs double-sided printing, printing is also performed on the surface (namely, the first main surface) of the recording paper 2a on the side provided with the cutter 16a. Therefore, it is particularly effective to prevent the first main surface of the recording paper 2a from damage caused by the cutter 16a.

In addition, according to the present invention, the above preferred embodiments can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A thermal printer, comprising:
a thermal head;
a platen roller disposed to face said thermal head;
a first path that guides recording paper drawn from a recording paper roll to one entrance of a gap between said thermal head and said platen roller such that a first main surface of said recording paper is on said thermal head side;
a second path that guides said recording paper drawn from said recording paper roll to the other entrance of the gap between said thermal head and said platen roller such that a second main surface of said recording paper is on said thermal head side; and
a switch guide that switches between said first path and said second path.

2. The thermal printer according to claim 1, further comprising:
a first print operation mode of switching said switch guide to said first path and guiding said recording paper into said first path to perform printing on said first main surface of said recording paper;
a rewind operation mode of rewinding said recording paper on which printing has been performed by said first print operation mode; and
a second print operation mode of switching said switch guide to said second path after said recording paper has been rewound by said rewind operation mode and guiding said recording paper into said second path to perform printing on said second main surface of said recording paper,
wherein said thermal printer performs printing on both said first and second main surfaces of said recording paper being connected to said recording paper roll.

3. The thermal printer according to claim 2, further comprising a housing path that houses said recording paper on which printing has been performed by said first print operation mode,
wherein said housing path is curved in the same direction as a winding direction of said recording paper roll.

4. The thermal printer according to claim 1, further comprising an ejection path that guides said recording paper to an ejection opening, said recording paper having passed through said second path, wherein
said ejection opening is provided with a cutter that cuts said recording paper, and
said ejection path has a distance greater than an effective print length in a unit screen of an ink sheet used in the thermal printer.

5. The thermal printer according to claim 2, further comprising an ejection path that guides said recording paper to an ejection opening, said recording paper having passed through said second path, wherein
said ejection opening is provided with a cutter that cuts said recording paper, and
said ejection path has a distance greater than an effective print length in a unit screen of an ink sheet used in the thermal printer.

6. The thermal printer according to claim 3, further comprising an ejection path that guides said recording paper to an ejection opening, said recording paper having passed through said second path, wherein
said ejection opening is provided with a cutter that cuts said recording paper, and
said ejection path has a distance greater than an effective print length in a unit screen of an ink sheet used in the thermal printer.
